(19) United States
(12) Patent Application Publication
(10) Pub. No.: US 2006/0076285 A1
(43) Pub. Date: Apr. 13, 2006

(54) Contaminant removal and containment machine

(76) Inventor: Leroy Eugene Lewandowski, Rockford, IL (US)

Correspondence Address: LEROY E. LEWANDOWSKI, 4401 WILDWOOD LANE, ROCKFORD, IL, 61101, US

(21) Appl. No.: 10/962,148

(22) Filed: Oct. 8, 2004

(51) Int. Cl. C02F 1/48

(52) U.S. Cl. 210/222; 210/223; 210/387; 210/401

(57) ABSTRACT

An apparatus is provided for removing contaminant from liquids and containing the material in a package. The apparatus includes an endless motorized belt carrying a replaceable media and a take-up roll. The belt is passed through a magnetic field causing the ferrous material to be held to the media, where it is carried to the take-up roll for containment in a package.

### FIELD OF INVENTION

This invention relates to liquid cleaning, specifically to the removal of ferrous material from liquids through the use of magnets or other means and then carrying off this contaminant on a media. This is an improvement over conveyortype and drum-type liquid cleaners now in use.

The essence of this invention is a conveyor with magnets affixed to a bed over which a conveyor belt moves, carrying a paper media.

### BACKGROUND

Liquids that are used primarily to cool parts or remove contaminant from a machining operation require cleaning. Historically, one method of removing contamination is with a fabric filtration mechanism similar to a coffee filter. Another method is to use magnetic attraction to pull the metal particles out of the coolant. In the case of magnetic attraction, the metal particles are held to the surface of a rotating drum or a conveyor belt. The particles are then carried out of the coolant into the path of a scraping device where they are removed.

Magnetic separators, which we will be discussing here are bulk cleaners, that is, they remove the bulk of the material. We will not be discussing “fabric filters” which pass the liquid through a fabric to strain out the contaminant. The invention described herein is an improvement over existing magnetic cleaning devices because it also “packages” the contaminant.

### Object

The object of this invention is to provide an effective and inexpensive means of removing large quantities of contaminant from liquids and then packaging the contaminant for easy disposal.

Disadvantages of Prior Art:

Both drum-type magnetic liquid cleaners and conveyor-type magnetic liquid cleaners use a scraping device to remove the separated contaminant from the surface of the belt or drum. This scraper is usually a metal or plastic blade that bears against the surface of the belt or drum. This design has a number of inherent flaws:
(a) Because the surface from which contaminant must be removed is not perfectly flat and the scraper is not perfectly flat some contaminant will bypass the scraper. This is particularly true at the seam of a welded drum. It is almost impossible to keep this area as completely round as the remainder of the drum. This creates an uneven surface from which it is difficult for the scraper to function efficiently. The contaminant that bypasses the scraper will then either remain on the magnetic surface reducing the effectiveness of further magnetic attraction; or will fall off into the clean coolant tank and contaminate the clean coolant.
(b) Secondly, the scraper and the surface it is scraping from are subject to wear, and this wear will not be evenly distributed across the surface. Therefore, more gaps build up between the scraper and the surface, which allows more contaminant to bypass. It ultimately reaches a point where most of the contaminant is passing under the scraper, thereby reducing the effectiveness of the cleaning action.
(c) The wear on both the scraper and the drum require that both must be replaced at some point. This is costly and time-consuming. The drum is the most expensive item on a drum-type separator. It is also the most difficult part to replace.
(d) The contaminant being removed must fall into a container, which is usually located 12″ to 16″ under the scraper. As a result, splashing occurs as the contaminant falls into the container. This creates wet spots on the floor. Since the coolant is composed of oils, synthetic oils, or in combination with water, the wet floor becomes both unsightly and a safety concern to foot traffic.
(e) The contaminant being removed also carries trapped coolant along with it. This coolant adds to the accumulation in the container, requiring the container to be emptied more frequently. And since the machine must be stopped for this operation and the container transported to a disposal location, more time and labor is lost. In addition, the liquid being removed is mostly water, but since it contains oils, it is considered hazardous and must be disposed of also. This adds to disposal costs.
(f) The coolant being carried off is formulated for each operation and contains essential ingredients that are also carried off. These needed ingredients must then be replaced at additional cost.
(g) The removed contaminant and coolant are considered hazardous waste. The cost of handling and hauling hazardous waste adds significantly to the cost of contaminant removal.
   Advantages of Using a Media Instead of a Scraper
a. Reduced Coolant Use: Most of the liquid is removed from the contaminant through the action of the take-up roll pressing on the belt. This liquid then runs back into the coolant reservoir for reuse. Even though this action removes most of the coolant, the rolls will remain somewhat wet. However, since the contaminant is in packages, these packages can then be suspended over a container and the remainder of the liquid allowed to drain out. Most of the coolant can be reclaimed in this manner and a dry package is produced.
b. Cleaner work area. There is no container required to hold the swarf (contaminant removed from the coolant) for disposal. Therefore there is no splashing of coolant into surrounding areas. Instead, the swarf is packaged for disposal.
c. Reduced Swarf Disposal Cost. After removing all the water through the drying process, the rolls can then be disposed of in a standard landfill, greatly reducing the cost of disposal. Or, the cost can be further reduced if the user has an incinerator, and can bum the rolls in his own facility.
d. It promotes safety. Without the problem of coolant splashing out of a swarf tank, the dangerous wet floor is eliminated. Oil, water, and contaminant are not carried to other areas, either by foot traffic, or by motorized vehicles.
e. In addition, work areas that are neat and clean provide a superior working environment. Employee morale is increased which encourages employees to carry this trait over into other areas of their work. The final result is a workplace that looks well, runs more efficiently, and presents a positive image of the company.
f. Without the abrasive wearing effect of a scraper, there is no wear on a conveyor belt or drum surface. Under normal usage, the belt will last indefinitely. Any maintenance on the unit will be confined to replacing the conveyor drive motor. The motor is conventional and will wear, as would any motor. The cost of maintenance will be considerably less than on drum-type conveyors.
g. A further advantage is with an optional timing device that permits the unit to be run intermittently. This allows swarf to build up on the media which itself acts as filter by entrapping non-ferrous material so efficiency is improved. The timer also permits full utilization of the media and reduces the operating time of the motor. This increases the lifespan of the motor and reduces the amount of media required.
h. Labor is saved. The floor does not require cleaning to remove oil and water that is splashed onto to floor.
i. It is environmentally sensitive. Since packages are dry, they do not require hazardous waste land filling, thus reducing the requirement for landfill space.

Further objects and advantages will become apparent from the consideration of the drawings and ensuing description.

### SUMMARY

This invention comprises a motor-driven conveyor belt carrying a media on which liquid and contaminant are discharged. The contaminant is removed from the liquid and carried off to be packaged for disposal.

### DRAWING FIGURES

In the drawings, closely related figures have the same number but different alphabetic suffixes.

FIG. 1 is a perspective view of the complete machine.

FIG. 2 is a perspective view identifying major components.

FIG. 3 is an exploded view of the basic machine.

FIG. 4 is an exploded view of the media feed device and take-up roll.

FIG. 5 shows the belt tensioning device.

FIG. 6 shows a side elevation of the machine as it appears during operation

### DRAWING REFERENCE NUMERALS

| | |
|---|---|
| 10 | Side Frame |
| 12 | Take-up Roll |
| 14 | Belt |
| 16 | Electrical Box |
| 18 | Media Feed Roll |
| 20 | Magnet Tray |
| 22 | Magnets |
| 24 | Bed |
| 26 | Idler Roller |
| 28 | Idler Roller Bearing |
| 30 | Drive Roller |
| 32 | Belt Adjusting Screw |
| 34 | Movable Belt Adjusting Bracket |
| 36 | Stationary Bracket |
| 38 | Belt Adjusting Screw Nut |
| 40 | Feed Roll Core |
| 42 | Feed Roll Bracket |
| 44 | Take-up Roll |
| 46 | Take-up Roll Shaft |
| 48 | Take-up Roll Shaft Guide |
| 50 | Locking Screw |
| 52 | Power Cord |

### DESCRIPTION

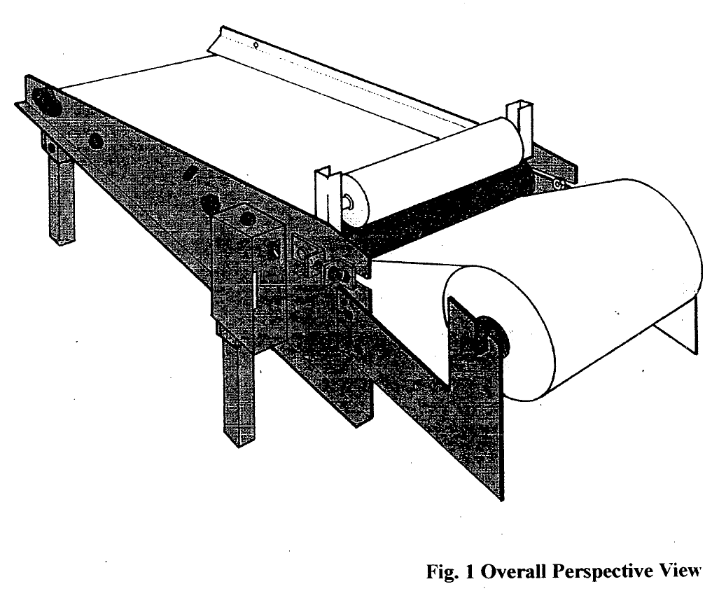

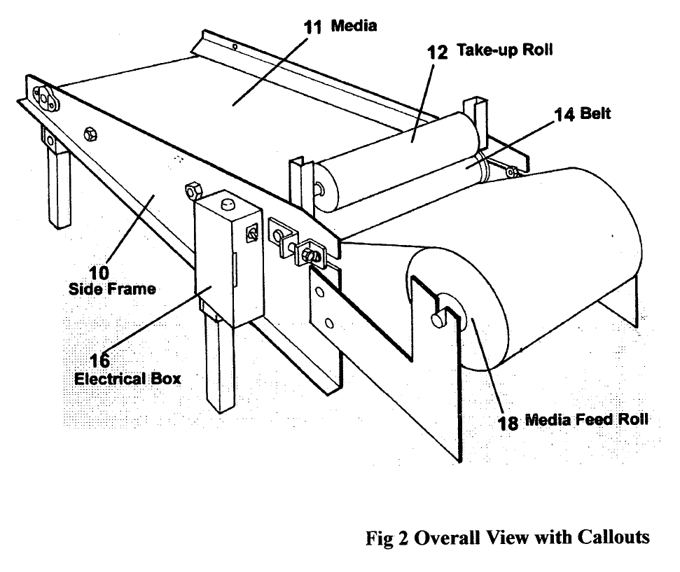

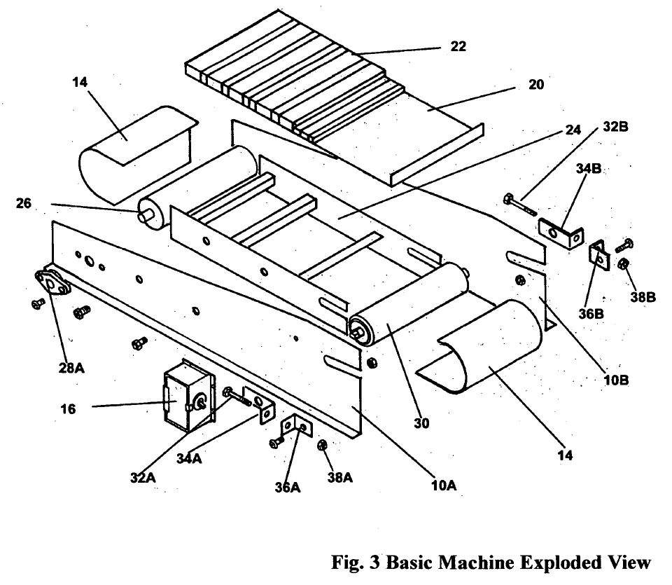

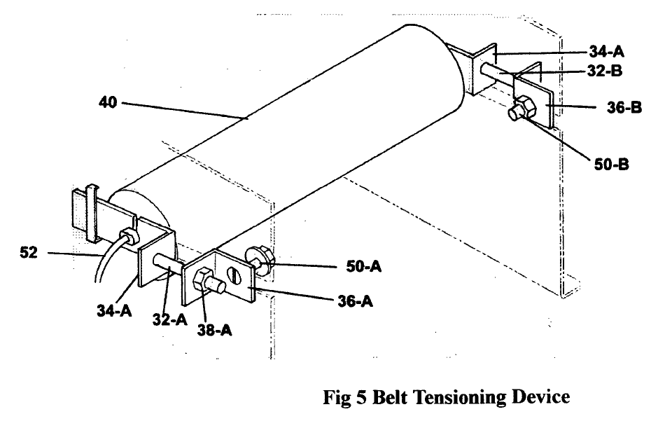

The embodiment of the present invention is shown in FIG. 1 (perspective view) and FIG. 2 (perspective view with parts identified). It is basically a conveyor. It consists of a framework (exploded view FIG. 3) with sides 10A and 10B holding Magnet Tray Support 24. A drive roller 30 located between the frames at the head supplies power to the unit. Shown in this embodiment is a self-contained roller and motor. However, other drive mechanisms can be used. An idler roller 26 located at the opposite end of the unit supplies friction-free rolling action for the belt. A belt 14 moves over said drive roller 30 and said idler roller 26. A tensioning device permits tightening of the belt to provide friction between the drive roller and the belt. FIG. 5.

The movable belt adjustment brackets 34-A and 34-B are attached to said drive roller 30. As the belt adjusting nuts 38-A AND 38-B are tightened, the drive roller 40 is moved forward to increase tension to the belt 14.

Power is supplied to the motor directly from an off-on switch located on the electrical box 16.

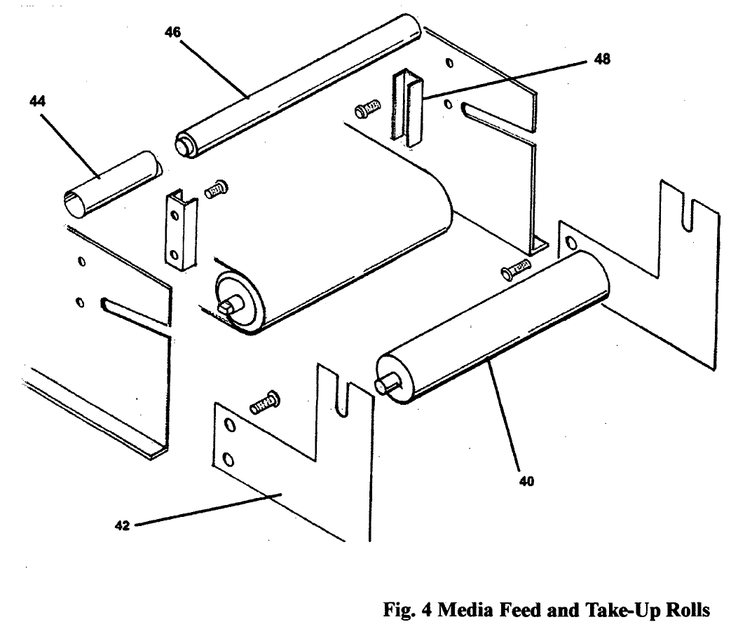

A Media Feed Roll FIG. 2 supplies media to the device. The media is fastened to the underside of the conveyor belt 14 and carried along with the belt. At startup, when the leading edge of the media reaches the take-up roller 12, it is removed from the belt and fastened to the Take-Up Roll Core 44 FIG. 4. Contact between the take-up roller 46 and belt 14 causes the roller to rotate, and in doing so rolls the fabric and contaminant into a package.

A second embodiment is a timing device used in conjunction with the on-off switch. In this embodiment controllers in the timer allow the unit to run the motor for a pre-set period of time and to allow the motor to rest for a preset period of time.

Operation

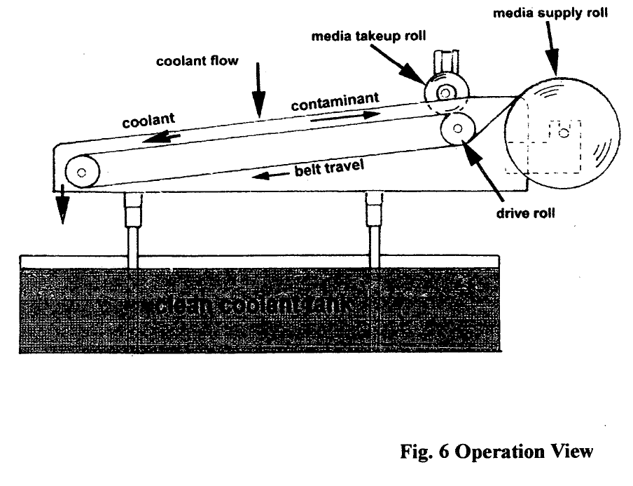

During use, the separator is positioned in or on the dean coolant tank (FIG. 6), and under the feeding device. Dirty coolant (coolant containing contaminant from the preceding operation) is introduced onto the media and allowed to run down the inclined surface of the media. In one embodiment, magnets located under the belt hold the metal particles, as well as other non-ferrous material entrapped in the metal swarf, to the media. As the belt moves, it carries the media and swarf to the take-up roll.

The take-up roll Assembly consists of a disposable core placed on the take-up roll shaft. The take-up roll shaft is loosely held between two vertical guides and free to rotate under contact with the moving belt. At startup, the media is withdrawn from the feed roll and fastened to the underside of the conveyor belt. When the belt is put into motion it pulls the media from the roll and carries it to the take-up roll. When the media reaches the take-up roll it is fastened to the take-up roll. During the coolant cleaning operation, the media carries the contaminant to the take-up roll and wraps it into a package as the roll rotates. This action traps the swarf and produces a roll of contaminant.

The pressure between the take-up roll and the belt also squeezes the coolant out of the swarf. The coolant from which the contaminant has been removed is allowed to travel down the inclined belt and falls into the clean coolant tank.

When the roll of media and contained swarf reaches a predetermined size, the machine stops and the roll of contaminant is removed. A new empty core is inserted and the machine is restarted. The process then repeats.

Full rolls are taken to a drying area, suspended over a coolant retrieval tank and allowed to drip dry. After drying, the rolls can be disposed of in a standard landfill, burned in an incinerator, disposed of in some other means.

From the foregoing description, a number of advantages become evident:
1. There is no need for a scraper blade to remove contaminant.
2. The swarf is rolled up into an easily disposed-of package.
3. Coolant is saved by being drained out of the swarf and re-introduced into the coolant tank.
4. No coolant is allowed to contaminate the work area and produce a safety hazard.
5. There are no areas of appreciable wear on the machine.
   Ramifications:

The reader can easily see that rolling up the swarf and allowing it to dry, a package of swarf is produced that is easy to handle. It is also in a condition that permits disposal in a standard landfill, obviating the cost of hazardous waste hauling. In addition, the process conserves most of the coolant for reuse. Media of different types can be used according to the means of disposal. And the work area remains free of unsightly and hazardous fluids.

Although the above description contains many details, it is not to be construed that these limit the scope of the machine. For instance, both feed rolls and take-up rolls can have different sizes and also shapes, thereby changing the amount of swarf that can be contained before a roll must be changed.

Thus, the scope of the invention should be determined by the appended claims and their legal equivalents, rather than by the examples given.

What is claimed is:

1. A machine for removing material from liquids and collecting the material into a package, consisting of:
a. A bed of magnets located within a frame
b. An endless belt free to move across said bed of magnets
c. A means of conveying rotational energy to said belt
d. A media in contact with the belt and moving with the belt
e. A horizontal roll rotating with the belt.
f. Support members locating the roll, permitting only rotational and vertical movement of the roll.
g. A replaceable core placed on the roll.
